(19) United States
(12) Patent Application Publication
(10) Pub. No.: US 2009/0103119 A1
(43) Pub. Date: Apr. 23, 2009

(54) IMAGE FORMING APPARATUS, OUTPUT METHOD OF COLOR IMAGE AND CONTROL PROGRAM THEREOF

(76) Inventors: Mitsuru OKUZAWA, Tokyo (JP); Koji Shakushi, Tokyo (JP); Hiroshi Miura, Tokyo (JP); Mitsuhiko Ota, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/128,370

(22) Filed: May 28, 2008

(30) Foreign Application Priority Data
Oct. 17, 2007 (JP) JP2007-270632

(51) Int. Cl. G06F 3/12

(52) U.S. Cl. 358/1.9; 382/167

(57) ABSTRACT

An image forming apparatus including an image acquisition section which acquires a color image; a memory section which stores a first table correlating a specific color with a symbol indicating the specific color; a color discrimination section which discriminates a color on the basis of color information of each portion in the color image, and extracts an area having the specific color; a symbol composition section which specifies the symbol corresponding to the specific color by reference to the first table, and composes the specified symbol into the area having the specific color in the color image to generate a composite color image; and an image output section which outputs the composite color image.

### CROSS-REFERENCE TO RELATED APPLICATION

The present application is based on Japanese Patent Application No. 2007-270632 filed with Japanese Patent Office on Oct. 17, 2007, the entire content of which is hereby incorporated by reference.

### BACKGROUND OF THE INVENTION

1. Field of Technology

The present invention relates to an image forming apparatus by which a color image is output, an output method of the color image, and a control program by which the color image is processed.

2. Description of Related Art

Image forming apparatuses such as a copying machine and a multi functional peripheral fitted with a color printing mechanism have become popular, and opportunities to print various color documents are increased. Herein, there are some users with minority color vision exhibiting different color recognition and identification to specific color (hereinafter, referred to as color vision defective), compared with majority color vision among users utilizing color prints, and in cases when the above-described specific color is included in the color prints, the color vision defective can not identify the color, or is difficult to identify it.

In order to improve convenience of such the color vision defective, an image processing apparatus by which color of display data for color-to-shape conversion is converted into the predetermined shape to output via classification of the color-to-shape conversion out of input display data is disclosed in Unexamined Japanese Patent Application No. 2004-178513(JP2004-178513A), for example. Further, a printer system by which color, within the pattern region which is difficult to be recognized by the color vision defective among images, is changed into the predetermined pattern or predetermined color is also disclosed in Unexamined Japanese Patent Application No. 2001-293926 (JP2001-293926A).

However, in the case of a method of changing a specific color in the color image into another color, when color equivalent to the above-described another color is present in the original color image, it can not be discriminated. Also in this method, when the color vision defective oneself does not understand the correspondence relationship between the specific color and the above-described another color, the part to which the specific color portion corresponds can not be identified.

Also in the case of a method of changing a specific color in the color image into the predetermined pattern, when a pattern equivalent to the above-described predetermined pattern is present in the original color image, it can not be discriminated. Also in this method, when the color vision defective oneself does not understand the correspondence relationship between the specific color and the above-described predetermined pattern, it can not be discriminated which part of pattern is the specific color portion.

Further, in any of the above-described methods, a plurality of colors each exhibiting different chroma and lightness can not be discriminated since color is distinguished on the basis of tint (or hue) of the specific color, and is to be distinguished as an identical color in the case of the identical tint, even though the specific color exhibits chroma or lightness at a different level.

The present invention has been made on the basis of the above-described situation. It is an object of the present invention to provide an image forming apparatus by which a color image including the specific color that is difficult to be identified by the color vision defective can be output in a distinguishable form, and also to provide an output method of the color image together with a control program by which the color image is processed.

### SUMMARY

In order to realize at least one of the above described objectives, an image forming apparatus reflecting one aspect of the present invention comprises an image acquisition section which acquires a color image; a memory section which stores a first table correlating a specific color with a symbol indicating the specific color; a color discrimination section which discriminates a color on the basis of color information of each portion in the color image, and extracts an area having the specific color; a symbol composition section which specifies the symbol corresponding to the specific color by reference to the first table, and composes the specified symbol into the area having the specific color in the color image to generate a composite color image; and an image output section which outputs the composite color image.

An image forming apparatus reflecting another aspect of the present invention, the memory section further stores a second table correlating a color information level of the specific color with a configuration of the symbol; the color discrimination section further extracts an area where color information of the discriminated color includes a predetermined color information level of the specific color; and the symbol composition section further specifies the configuration of the symbol corresponding to the color information level of the specific color by reference to the second table, and composes the specified symbol with the specified configuration of the symbol into the area having the specific color.

### BRIEF DESCRIPTION OF THE DRAWING

These and other objects, advantages and features of the invention will become apparent from the following description thereof taken in conjunction with the accompanying drawings in which:

FIG. 1(a) and FIG. 1(b) each is a diagram showing an external view of an image forming apparatus relating to an example of the present invention;

FIG. 2 is a block diagram showing a structure of an image forming apparatus relating to an example of the present invention;

FIG. 3 is a flow chart diagram showing the output procedure of color images employing an image forming apparatus relating to an example of the present invention;

FIG. 4(a) to FIG. 4(c) respectively are diagrams showing an image of the original, and an image after symbol composition and a manner how color vision defective views, relating to an example of the present invention;

FIG. 5(a) to FIG. 5(c) respectively are diagrams showing an image of the original (in the case of a mixture of color mixed with the specific color), and an image after symbol composition and a manner how color vision defective views, relating to an example of the present invention;

FIGS. 6(a), FIG. 6(b) and FIG. 6(c) respectively are diagrams showing an image of the original (in the case of varied brightness of the specific color), and an image after symbol composition in different density and a manner how color vision defective views, relating to an example of the present invention;

FIGS. 7(a), FIG. 7(b) and FIG. 7(c) respectively are diagrams showing an image of the original (in the case of varied brightness of the specific color), and an image after symbol composition in different size and a manner how color vision defective views, relating to an example of the present invention;

FIGS. 8(a), FIG. 8(b) and FIG. 8(c) respectively are diagrams showing an image of the original (in the case of varied brightness of the specific color), and an image after symbol composition in different concentration and a manner how color vision defective views, relating to an example of the present invention;

FIGS. 9(a), FIG. 9(b) and FIG. 9(c) respectively are diagrams showing an image of the original (in the case of a mixture of a plurality of specific colors and varied brightness of the specific color), and an image after symbol composition and a manner how color vision defective views, relating to an example of the present invention;

FIG. 10(a), FIG. 10(b) and FIG. 10(c) respectively are diagrams showing another example of an image after symbol composition relating to an example of the present invention; and

FIG. 11(a), FIG. 11(b) and FIG. 11(c) each are diagrams showing an example of an area in size of the specific color relating to an example of the present invention.

### DETAILED DESCRIPTION OF THE PREFERRED EMBODIMENT

In recent years, an image forming apparatus equipped with a color printing mechanism has become popular. Three kinds of sensors corresponding to three primary colors of red, green and blue light are installed in a scanner section of the image forming apparatus so as to precisely reproduce colors of the color image with this image forming apparatus. And distinguished is color based on output values (RGB value) obtained from three kinds of sensors with respect to each portion of the color image, referring to Table 1, and the color is reproduced by arranging to mix toner for each color of yellow, magenta and cyan as three primary paint colors and transferred onto a paper sheet.

TABLE 1

| RGB value | Red | Yellow | Green | Cyan | Blue | Magenta |
|---|---|---|---|---|---|---|
| R | 255 | 255 | 0 | 0 | 0 | 255 |
| G | 0 | 255 | 255 | 255 | 0 | 0 |
| B | 0 | 0 | 0 | 255 | 255 | 255 |

However, human vision varies between individuals, and in the case of users with minority color vision exhibiting different color recognition and identification (so-called color vision defective), compared with majority color vision, red and green are generally difficult to be distinguished. Therefore, the color vision defective is not always able to precisely distinguish the original color of the color image from the print, even though color of the color image is precisely reproduced and printed. Accordingly, in the above-described Patent Documents (JP2004-178513A and JP2001-293926A), the specific color is designed to be distinguishable by changing the specific color into another color or pattern. However, in the case of these methods, when color or pattern equivalent to the above-described another color or pattern is included in the original color image, such color or pattern can not be distinguished, and the part of specific color portion can not also be identified unless the correspondence relationship between the specific color and the above-described another color or pattern is understood.

In the present embodiment, without changing the specific color which is difficult to be identified by the color vision defective into another color or pattern, employed is a method by which symbols such as characters and marks indicating the specific color are composed into an area of the specific color to conduct outputting. Specifically, a color discrimination section of distinguishing color for each portion of the color image to extract an area of the specific color which is difficult to be identified by the color vision defective, and a symbol composition section of composing the symbol indicating the specific color into the area of each specific color are provided as hardware or software in an image forming apparatus.

This can identify the specific color by confirming the symbol, even though the specific color which is difficult to be discriminated by the color vision defective is included.

Further, each color is expressed by three attributes of color such as hue indicating tint, lightness indicating brilliance, and chroma indicating color saturation, and the color tends to be recognized to human eyes as a different color in the case of different chroma and lightness even though it is the same kind of color (that is, color of equivalent hue). For example colors, distinguished as red by the hue, exhibits various colors such as showy red like “rose color”, somber red like “daphne color”, the medium color like “Bordeaux color” and so forth depending on chroma; and also exhibits various colors such as bright red like “coral red”, dark red like “Bordeaux color” and so forth depending on lightness.

In the present embodiment, kinds of the specific color as well as the color information level are distinguished in the color discrimination section, and the configuration of density, size, concentration and so forth of the symbol depending on the color information level is changed and composed in the symbol composition section. For example, when an output value (RCB value) of each sensor of RGB is in the range of Table 2, it is distinguished as “red”, but the density of the symbol composed is changed based on the R value as shown in Table 3 since chroma and lightness are varied in the case of the different output value (R value) of a sensor of R. Further, similarly in cases where the RCB value is in the range of Table 4, it is distinguished as “green”, but the density of the symbol composed based on the G value is changed as shown in Table 5 since chroma and lightness are varied in the case of the different G value. Furthermore, similarly in cases where the RCB value is in the range of Table 6, it is distinguished as “yellow”, but the density of the symbol composed based on the R value and G value is changed as shown in Table 7 since chroma and lightness are varied in the case of the different R value and G value.

TABLE 2

| RGB value | Range of red detection |
|---|---|
| R | 100-255 |
| G | 0-99 |
| B | 99-0 |

TABLE 3

| R value | Density of symbol (RGB value) |
|---|---|
| 100-130 | All 30 |
| 131-160 | All 100 |
| 161-190 | All 210 |
| 191-220 | All 245 |
| 221-255 | All 255 |

TABLE 4

| RGB value | Range of green detection |
|---|---|
| R | 99-0 |
| G | 100-255 |
| B | 0-99 |

TABLE 5

| G value | Density of symbol (RGB value) |
|---|---|
| 100-130 | All 30 |
| 131-160 | All 100 |
| 161-190 | All 210 |
| 191-220 | All 245 |
| 221-255 | All 255 |

TABLE 6

| RGB value | Range of yellow detection |
|---|---|
| R | 100-255 |
| G | 100-255 |
| B | 0 |

TABLE 7

| R value and G | |
|---|---|
| value | Density of symbol (RGB value) |
| 100-130 | All 30 |
| 131-160 | All 100 |
| 161-190 | All 210 |
| 191-220 | All 245 |
| 221-255 | All 255 |

This can improve convenience of the color vision defective since the different specific color at the color information level can be arranged to be identified as a different color.

### EXAMPLE 1

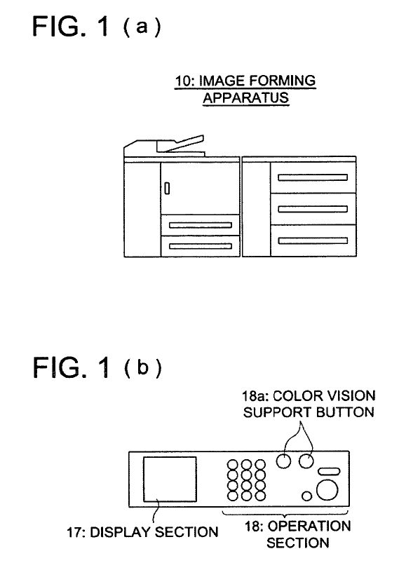

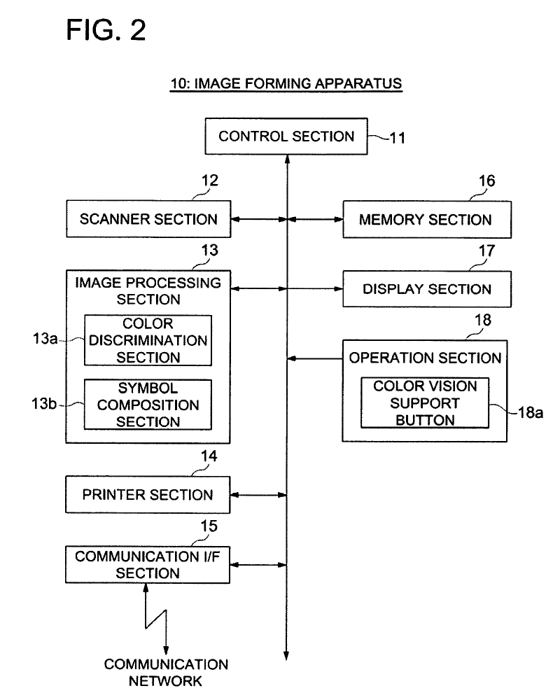

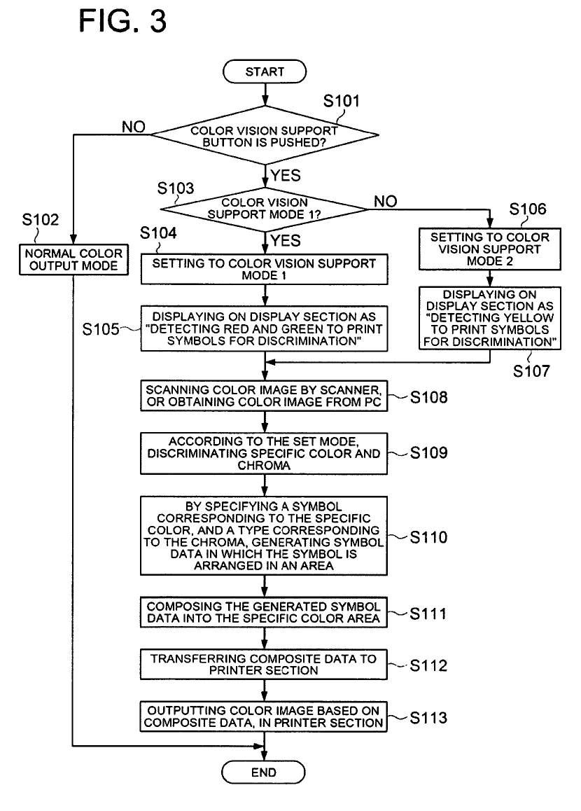

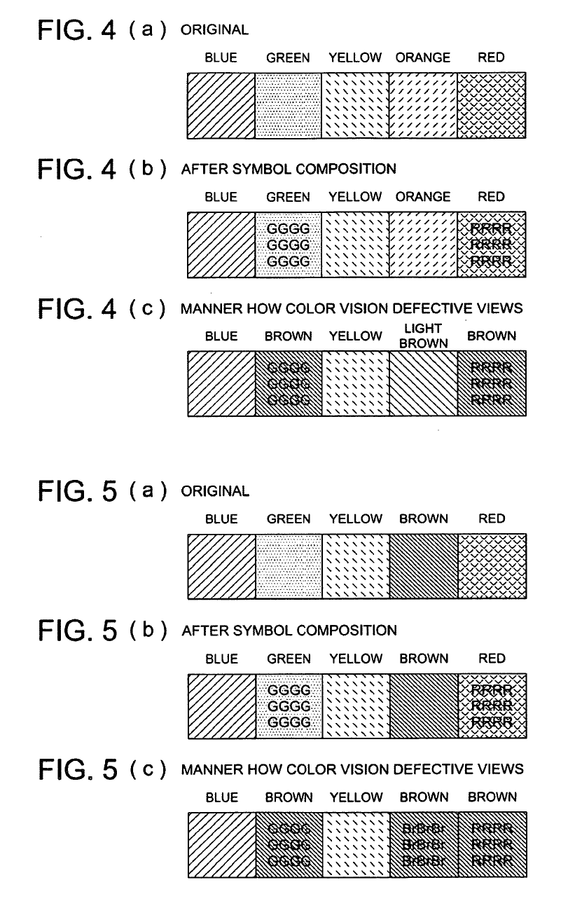

In order to explain the above-described embodiments of the present invention in detail, an image forming apparatus and an output method and a control program of a color image, relating to an example of the present invention, will be described referring to FIG. 1(a)-FIG. 11(c). Each of FIG. 1(a) and FIG. 1(b) is a diagram showing an external view of an image forming apparatus relating to an example of the present invention, and FIG. 2 is a block diagram showing a structure of an image forming apparatus relating to an example of the present invention. FIG. 3 is also a flow chart diagram showing the output procedure of color images employing an image forming apparatus relating to an example of the present invention. Further, each of FIG. 4(a)-FIG. 10(c) is a diagram showing an example of outputting a color image employing an image forming apparatus in the present Example, and each of FIG. 11(a)-FIG. 11(c) is a diagram showing the size in the range of specific color for symbol composition.

As shown in FIG. 1(a), image forming apparatus 10 in the present Example is equipped with a function (hereinafter, referred to as a vision support function) in which the obtained color image is analyzed, and characters, marks and the like (hereinafter, referred to as symbols) indicating each specific color are composed into an area of the color which is difficult to be identified by the color vision defective (hereinafter, the color is referred to as specific color).

Specifically, as shown in FIG. 2, this image forming apparatus 10 is fitted with control section 11, scanner section 12, image processing section 13, printer section 14, communication I/F section 15, memory section 16, display section 17, operation section 18 and so forth, and each of the sections is bus-connected.

Control section 11 is composed of CPU (Central Processing Unit), ROM (Read only Memory), RAM (Random Access Memory) and so forth. CPU reads out each program stored in ROM via operation of operation section 18 to expand in the RAM, and controls operation of each section in image forming apparatus 10 based on the expanded program.

Scanner section 12 reads color information (RGB value) of a color image, and is composed of a light source to scan an original document, a sensor to detect each color of CCD (Charge Coupled Device) or such to convert light reflected by the original document into an electrical signal, an A/ D converter to conduct A/D conversion of the electrical signal, and so forth.

Image processing section 12 conducts color conversion into YMCK data from RGB data, each image processing such as tone correction and so forth to output the signal to printer section 14. In the present Example, specifically when color vision support button 18a is operated, image processing section 12 functions as color discrimination section 13a in which color is distinguished based on color information in each area of a color image referring to a previously stored table to extract a continuous area of the specific color (often called specific color area), and also functions as symbol composition section 13b in which the symbol corresponding to the specific color is composed into an area of each specific color by changing configuration of density, size, concentration and so forth, as necessary.

Specifically, in the case of the specific color set by color vision support button 18a being “red”, when an RGB value in each section of the color image is in the range of Table 2, color of the area is distinguished as the specific color, and in which level the R value of the area belongs in Table 3 is further distinguished. Similarly, in the case of the specific color being “green”, when an RGB value in each area of the color image is in the range of Table 4, color of the area is distinguished as the specific color, and in which level the G value of the area belongs in Table 5 is further distinguished. Similarly, in the case of the specific color being “yellow”, when an RGB value in each area of the color image is in the range of Table 6, color of the section is distinguished as the specific color, and in which level the R value and the G value of the area belong in Table 7 is further distinguished. And, based on the discrimination result of each area, an area exhibiting the specific color (a continuous area of the specific color in which color information is at a predetermined level, as required) is extracted.

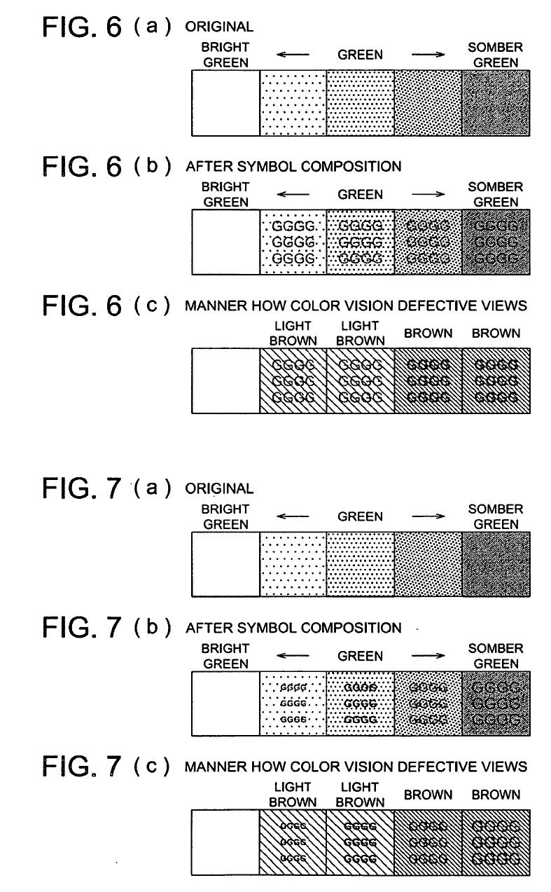

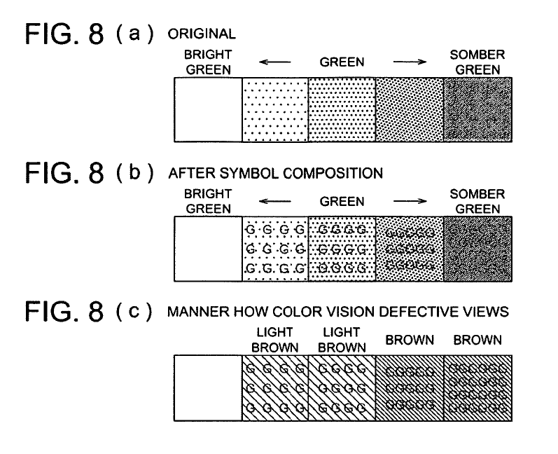

Further, in cases where colors of the color image are of the structure of FIG. 4(a), symbols such as “R” as the capital letter of red if the specific color is red, “G” as the capital letter of green if the specific color is green, and “Y” as the capital letter of yellow if the specific color is yellow, and so forth are composed. Further, in cases where a color information level of the specific color varies, they are composed by changing configuration of symbols depending on the color information level. For example, in cases where brightness varies as shown in FIG. 6(a), the more somber the specific color becomes, the higher (or the lower) the density of symbol is made, and the brighter the color becomes, the lower (or the higher) the density of symbol is made. Further, as shown in FIG. 7(b), the more somber the specific color becomes, the larger (or the smaller) the size of symbol is made, and the brighter the color becomes, the smaller (or the larger) the size of symbol is made. As shown in FIG. 8(b), the more somber the specific color becomes, with no change of the symbol in size, the narrower (or the wider) a symbol interval is made, and the brighter the color becomes, the wider (or the narrower) a symbol interval is made.

In addition, the above-described color discrimination section 13a and symbol composition section 13b may be arranged as hardware, and may also be arranged as a control program which allows a computer to function as color discrimination section 13a and symbol composition section 13b in image forming apparatus 10.

Printer section 14 is composed of an image forming section to form an image for printing onto a transfer paper sheet, a transfer section to transfer the formed image onto the transfer paper sheet, a fixing section to fix the transferred image, a conveyance section to convey the transfer paper sheet, a cleaning section to clean the image forming section, the transfer section, the fixing section and so forth, and the image is formed on the transfer paper sheet to be output, based on input data via an electrophotographic system.

Communication I/F section 15 is equipped with an NIC (Network Interface Card), a modem, a LAN adapter, a router, a TA (Terminal Adapter) and so forth, and conducts communication-control with devices connected via communication network.

Memory section 16 is configured with a flash memory, a hard disk and so forth, and stores various data, setting conditions and so forth. In the present Example, it specifically stores a table to distinguish color as well as chroma based on color information (RGB value) in each area of the color image, a table indicating the correspondence relationship between each specific color and symbol, a table indicating the correspondence relationship between chroma of each specific color and configuration of the symbol, and so forth.

Display section 17 is composed of a liquid crystal display (LCD: Liquid Crystal Display) device, an organic EL (electroluminescence) display device and so forth. Operation section 18 is fitted with various buttons and switches. Color vision support button 18a to indicate a color vision function by which the symbol is composed into the specific color. One button may be allowed to be used as color vision support button 18a, but since the color vision defective has respective different color which is difficult to be identified, a plurality of buttons may be allowed to be used as color vision support button 18a, and the color in which the symbol is composed can be changed, depending on selected color vision support button 18a, may be allowed to be designed. In cases where a plurality of buttons are provided as color vision support button 18a, color vision support button 18a may be separated by colors distinguishable by the color vision defective, and characters, marks and such clearly indicating the specific color may be displayed to each color vision support button 18a, in order to clarify the corresponding relationship between each color vision support button 18a and the specific color to compose the symbol.

FIG. 1 and FIG. 2 are shown as an example having the color vision support function, and other configurations may be feasible as far as having the function of color vision support. In FIG. 2, scanner section 12 by which a color image is acquired is installed in image forming apparatus 10, but a system, in which a computer device and image forming apparatus 10 are connected with a communication network such as LAN (Local Area Network), WAN (Wide Area Network) and so forth, may be of the structure in which color image data are obtained from the computer device and such.

Next, the procedure up to the step of outputting a color image employing image forming apparatus 10 of the above-described structure will be described referring to the flow chart diagram of FIG. 3. In the present embodiment, the flow chart diagram shows a control in which a program stored in the ROM is read out to be expanded in the RAM, and the expanded program is executed. Accordingly, each of scanner section 12, color discrimination section 13a, symbol composition section 13b and display section 17 execute operation or control via operation control of control section 11, as described below.

First, users decide whether a color image acquired in scanner section 12 or a color image acquired via communication I/F section 15 is directly printed or printed by composing the symbol into an area of the specific color. In cases where the symbol is composed into an area of the specific color, the users push down predetermined color vision support button 18a in operation section 18 to select a predetermined color vision support mode (herein, color vision support mode 1 in which red and green are the specific color, or color vision support mode 2 in which yellow is the specific color). In addition, one color vision support mode is allowed to be used, and another color vision support mode may also be allowed to be added. In place of pushing down color vision support button 18a, also used may be, for example, a structure in which a color vision attribute of each of the color vision defectives is stored in a memory card such as an IC card or the like, and information inside the card is read out by an IC card reader previously installed in image forming apparatus 10.

Next, control section 11 monitors whether color vision support button 18a has pushed down at step S101, and in cases when printing has been directed without pushing down color vision support button 18a, color printing is conducted in a normal color output mode at step S102. On the other hand, in cases when color vision support button 18a has been pushed down at step A101, control section 11 decides which color vision support button 18a has been pushed down at step S103 to an identify selected color vision support mode.

In the case of setting in color vision support mode 1, red and green are arranged to be set as the specific color at step S104 to inform color discrimination section 13a. Further, at step S105, control section 11 informs setting in color vision support mode 1 to users by displaying information such as “symbol is printed so as to be distinguishable via detection of red and green” in display section 17, if desired.

On the other hand, in the case of setting in color vision support mode 2, yellow is arranged to be set as the specific color at step S106 to inform color discrimination section 13a. Further, at step S107, control section 11 informs setting in color vision support mode 2 to users by displaying information such as “symbol is printed so as to be distinguishable via detection of yellow” in display section 17, if desired.

Next, when the original document having a recorded color image is set to image forming apparatus 10 at step S108, and users operate operation section 18 to direct scanning, the original document is scanned by a light source, light reflected by the original document is received by a CCD image sensor and converted into an electrical signal, and the electrical signal is A/C-converted to output color information of a color image into image processing section 13. In addition, in cases where the color image is acquired from a computer device via a communication network, control section 11 conducts controlling to acquire the color image employing communication I/F section 15 in place of the above-described scanning operation. Herein, the original document is arranged to be read by scanner section 12 after determining whether a color vision support function is used or not, but after reading the original document in scanner section 12, whether the color vision support function is used or not may be determined.

Next, at step S109, color discrimination section 13a acquires an RGB value of each section in a color image, and color corresponding to the RGB value according to Table 1 is distinguished to extract an area in which the specific color corresponding to the arranged color vision support mode is continuous. Further, a level of the RGB value is distinguished to extract a region in which the specific color at the predetermined level of the RGB value is continuous, as necessary. Specifically, in the case of setting in color vision support mode 1, the RGB value distinguishes color in the rage of Table 2 or Table 4 as the specific color, and also in the case of setting in color vision support mode 2, the RGB value distinguishes color in the rage of Table 6 as the specific color.

In addition, though the region of extracted specific color can be appropriately arranged to be set, the lower limit is set to a width of about 2.8 mm with which 8 point character is distinguishable, and normal color processing may be designed to be conducted for the region smaller than the limit, since the symbol gets out of the region, or size of the symbol becomes smaller, so that identifying is difficult to be conducted when the symbol is composed into the small area. Specifically, FIG. 11 indicates the limit in a region of the specific color into which the symbol is composed. FIG. 11(a) indicates the case smaller than the limit, and FIG. 11(b) and FIG. 11(c) indicate the case larger than the limit.

Next, at step S110, symbol composition 13b identifies the symbol corresponding to the specific color according to a color vision support mode referring to a table stored in memory section 16, and configuration such as density, size or concentration is specified from a level of the RGB value, as necessary, to produce symbol data where the identified symbol is arranged in the area in the specified configuration. Specifically, in cases where the specific color is “red”, the density of symbol is determined based on a level of the R value, referring to Table 3. In cases where the specific color is “green”, the density of symbol is also determined based on a level of the G value, referring to Table 5. In cases where the specific color is “yellow”, the density of symbol is also determined based on a level of the R value and a level of the G value, referring to Table 7. In addition, the color of symbol may be any color distinguishable by a color vision defective, but is preferably black.

Next, at step S111, symbol composition section 13b composes the generated symbol data into an area of the specific color, at step S112 the composed data are transferred into printer section 14, and at step S113 printer section 14 forms an image to be printed on a transfer paper sheet from the composed data, and the resulting image is transferred onto the transfer paper sheet to conduct outputting after fixing the transferred image. Wherein, the composed data are not necessarily printed, may be displayed in display section 17, transmitted to a computer device or such which is connected via a communication network, or may be printed by another image forming apparatus by being transmitted to the another image forming apparatus which is connected via the communication network.

What kind of the color image is output at the above-described steps will be described below referring to FIG. 4(a) to FIG. 10(c). The image example of the original document is shown in FIGS. 4(a), 5(a), . . . , 10(a), and kinds of hatching are changed in such a way that each color can be distinguished to display it. Further, the image example, in which the symbol is composed into an area of the specific color, is shown in FIGS. 4(b), 5(b), . . . , 10(b), and the actual view of how a color vision defective views the image of FIGS. 4(b), 5(b), . . . , 10(b), is shown in FIGS. 4(c), 5(c), . . . 10(c).

For example, in cases where the original document has the color configuration as shown in FIG. 4(a), the composition is made in such a way that a symbol of “R” is continuously repeated within the area corresponding to “red”, and a symbol of “G” is continuously repeated within the area corresponding to “green” to be output as shown in FIG. 4(b), provided that color vision support mode 1 is set. And, although the area of “red” and the area of “green” are observed as brown by a color vision defective as shown in FIG. 4(c), but it can be distinguished that color of the area is “red” or “green” by confirming a symbol of “R” or “G” in each area.

In addition, as shown in FIG. 5(a), though “brown” portion is possibly present in the original document, it is understood that the portion is “red” or “green” if a symbol of “R” or “G” is composed into the portion seen as “brown”, and that the portion is original “brown” if no symbol is composed. Accordingly, there is no problem even though color which is difficult to be identified by a color vision defective is only set to the specific color, but as shown in FIG. 5(b), not only a symbol of “R” is composed into an area corresponding to “red”, and a symbol of “G” is composed into an area corresponding to “green”, but also a symbol of “Br” as the capital letter and subscript notation can be composed into an area corresponding to “brown” in order to identify the color more clearly. And, the area of “red”, the area of “green” and the area of “brown” are totally seen as brown when observed by the color vision defective as shown in FIG. 5(c), but it can be distinguished that color of the area is “red”, “green” or “brown” by confirming a symbol of “R”, “G” or “Br” in each area.

In cases where the original document includes green exhibiting different chroma as shown in FIG. 6(a), the composition is made in such a way that a symbol of “G” is continuously repeated in the area to conduct outputting when color vision support mode 1 is set. In this case, the density of the symbol is set depending on chroma of each area, and the composition is made in such a way that a symbol of “G” is continuously repeated with the set density in the area to conduct outputting as shown in FIG. 6(b). And in the case of being observed by a color vision defective, the second portion and the third portion from the left are seen as light brown, and the fourth portion and the fifth portion from the left are seen as brown, as shown in FIG. 6(c), but whether the area is bright “green” or somber “green” can be identified by the density of the symbol of “G” in each area.

As shown in FIG. 7(b), as another example, the composition may also be made in such a way that size of the symbol is arranged to be set depending on chroma of each area, and a symbol of “G” is continuous in the area in set size. In this case, as shown in FIG. 7(c), whether the area is bright “green” or somber “green” can be identified by confirming size of a symbol of “G” in each area.

As shown in FIG. 8(b), as another example, the composition may also be made in such a way that concentration (letter space or line space) of the symbol is arranged to be set depending on chroma of each area, and a symbol of “G” is continuously repeated in the area in set concentration. In this case, as shown in FIG. 8(c), whether the area is bright “green” or somber “green” can be identified by the concentration of the symbol “G” in each area.

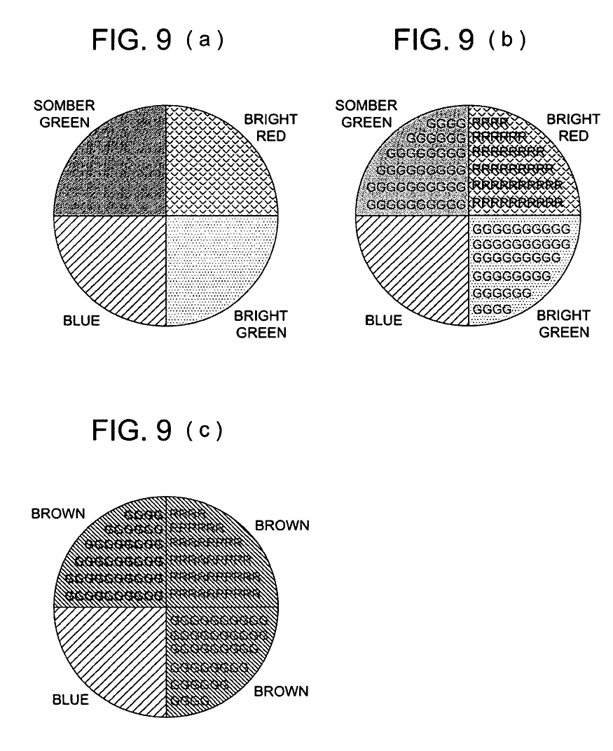

The case where an image of a circle graph is output is also shown in FIG. 9 as another example. In cases where the original document image is composed of “bright red”, “bright green”, “somber green” and “blue” as shown in FIG. 9(a), the composition is made in such a way that a symbol of “R” is continuously repeated in an area corresponding to “red” within the area, and a symbol of “G” is continuously repeated in an area corresponding to “green” within the area to conduct outputting if color vision support mode 1 is arranged to be set, but in this case, as shown in FIG. 9(b), the density of the symbol is arranged to be set depending on chroma in the area of “green”, and the composition is made in such a way that a symbol of “G” is continuously repeated in the area in set density to conduct outputting. And in the case of being observed by a color vision defective, any of upper left, upper right and lower right is seen as brown, as shown in FIG. 9(c), but whether upper left is “somber green”, upper right is “bright red”, and lower right is “bright green” can be identified by the symbol and its density in each area.

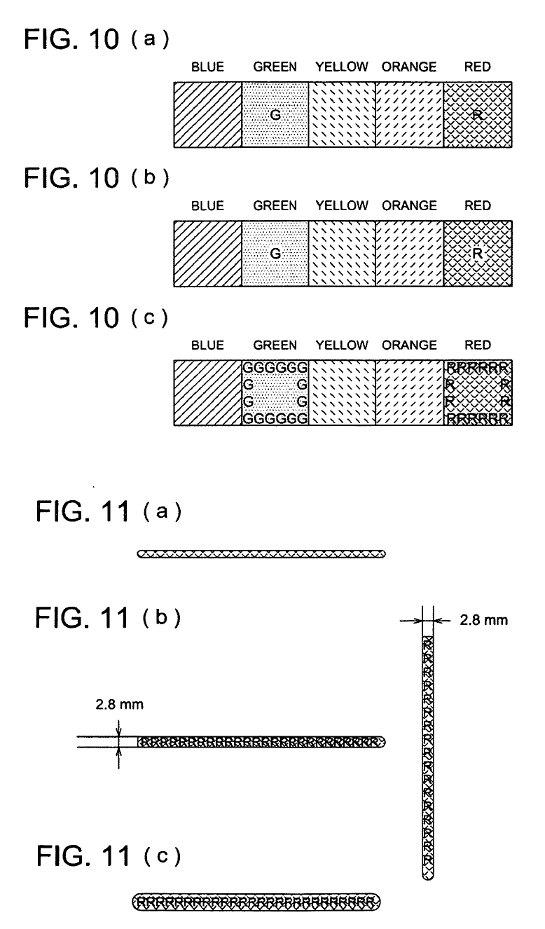

Further, an example of continuously composing the symbol corresponding to the specific color into an area of the specific color is shown in FIG. 4 and FIG. 9, but for example, one symbol or a few symbols may be composed into each area by reducing the number of symbols composed into an area of each specific color as shown in FIG. 10(a). In this configuration, in cases where the area of the specific color is small, and the specific color also has a lot of areas, an image of the original document can be designed not to be degraded via composition of the symbol. In cases where patterns and characters are mixed in the area of the specific color, the symbol is possibly difficult to be identified. In such the case, the symbol may be clearly displayed by turning the circumference of the symbol white or such, as shown in FIG. 10(b). Further, symbols may be arranged to be placed on the edge of the area, and this configuration becomes easily capable of recognizing the outline of the area.

In this way, image forming apparatus 10 is fitted with color discrimination section 13a and symbol composition section 13b as hardware or soft ware. No matter what color is employed for the original document, the specific color becomes identifiable, whereby convenience of a color vision defective can be improved, since the specific color which is difficult to be identified by a color vision defective is extracted from a color image as a printing object by color discrimination section 13a, and the symbol corresponding to the specific color is composed into an area of the specific color in configuration according to the color information level by symbol composition section 13b.

Incidentally, the case of using capital letters of the names for colors in English as symbols has been shown in the above-described Examples, but this symbol may be other type of identifiable letter or mark capable of easily identifying the color. For example, names and capital letters of words for colors in Kanji, Hiragana and Katakana, graphic symbols recalling colors, and so forth can also be utilized.

In the above-described Example, the specific color has been discriminated, based on the RCB value in each area of a color image, but color information is not limited to the RGB value, and can be appropriately changed in accordance with a structure of a sensor to detect color.

Further, the case where image forming apparatus 10 is fitted with color discrimination section 13a and symbol composition section 13b is shown in the above-described Example, but the present invention is not limited to the above-described Example, and also provided may be a structure in which a color image composed with symbols obtained by a computer device such as a personal computer or the like installed with color discrimination section 13a and symbol composition section 13b is displayed in a display section, and composition data of the symbol are transmitted to an image forming apparatus to conduct printing with the image forming apparatus.

The present invention is applicable to an image forming apparatus capable of color printing, a computer device, a method of outputting a color image with these devices, and a control program operated by these devices.

A color image including the specific color which is difficult to be identified by a color vision defective can be output in an identifiable form by utilizing an image forming apparatus, a method of outputting a color image and a control program of the present invention.

The reason is that since an area of the specific color which is difficult to be identified by the color vision defective is extracted by discriminating color in each area of a color image, and symbols such as characters marks indicating the specific color are composed into each of the specific color areas to conduct outputting, the specific color can be easily identified by confirming the symbols.

Further, the reason is that since hue of the specific color, chroma and lightness are distinguished, and the configurations such as the density, size and concentration of the symbol in accordance with the chroma and lightness are changed to make the composition, the specific color exhibiting different chroma and lightness can be easily identified by confirming the configuration of the symbols.

What is claimed is:

1. An image forming apparatus comprising:
an image acquisition section which acquires a color image;
a memory section which stores a first table correlating a specific color with a symbol indicating the specific color;
a color discrimination section which discriminates a color on the basis of color information of each portion in the color image, and extracts an area having the specific color;
a symbol composition section which specifies the symbol corresponding to the specific color by reference to the first table, and composes the specified symbol into the area having the specific color in the color image to generate a composite color image; and
an image output section which outputs the composite color image.

2. The image forming apparatus of claim 1, wherein,
the memory section further stores a second table correlating a color information level of the specific color with a configuration of the symbol;
the color discrimination section further extracts an area where color information of the discriminated color includes a predetermined color information level of the specific color; and
the symbol composition section further specifies the configuration of the symbol corresponding to the color information level of the specific color by reference to the second table, and composes the specified symbol with the specified configuration of the symbol into the area having the specific color.

3. The image forming apparatus of claim 2, wherein
the color information comprises R G B values; and
the color information level is a level of R value in cases where the specific color is red, a level of G value in cases where the specific color is green, and a level of R and G values in cases where the specific color is yellow.

4. The image forming apparatus of claim 1, further comprising:
an indication button for selecting one or plural symbol composition modes to compose the symbol into the color image by indicating the specific color.

5. The image forming apparatus of claim 1, wherein the symbol composition section arranges the symbol within the area having the specific color to generate the composite color image.

6. The image forming apparatus of claim 1, wherein the symbol comprises a capital letter of a name of the specific color.

7. The image forming apparatus of claim 1, wherein the specific color comprises a color which is difficult to be discriminated by a color vision defective.

8. The image forming apparatus of claim 1, wherein the specific color comprises a first color which is difficult to be discriminated by a color vision defective and a second color, where the color vision defective recognizes the first color as the second color.

9. A color image output method comprising:
an image acquiring step to acquire a color image;
a color discriminating step to discriminate a color on the basis of color information of each portion in the color image, and to extract an area having a specific color;
a symbol composing step to specify a symbol corresponding to the specific color by reference to a first table correlating the specific color with the symbol indicating the specific color, and to compose the specified symbol into the area having the specific color in the color image to generate a composite color image; and
an image outputting step to output the composite color image.

10. The color image output method of claim 9, wherein
the symbol composing step further specifies a configuration of the symbol corresponding to a color information level of the specific color by reference to a second table correlating the color information level of the specific color with the configuration of the symbol, and composes the specified symbol with the specified configuration into the area having the specific color to generate the composite color image.

11. The color image output method of claim 10, wherein
the color information comprises R G B values; and
the color information level is a level of R value in cases where the specific color is red, a level of G value in cases where the specific color is green, and a level of R and G values in cases where the specific color is yellow.

12. The color image output method of claim 9, further comprising:
an indicating step to select a mode from one or plural symbol composition modes to compose the symbol into the color image by indicating the specific color; wherein when the mode is indicated in the indicating step, the color discriminating step and the symbol composing step are executed with respect to the specific color indicated by the selected mode.

13. The color image output method of claim 9, wherein the symbol composing step arranges the symbol within the area having the specific color to generate the composite color image.

14. The color image output method of claim 9, wherein the symbol comprises a capital letter of a name of the specific color.

15. The image forming apparatus of claim 1, wherein the specific color comprises a color which is difficult to be discriminated by a color vision defective.

16. The color image output method of claim 9, wherein the specific color comprises a first color which is difficult to be discriminated by a color vision defective and a second color, where the color vision defective recognizes the first color as the second color.

17. A computer-readable storage medium recorded thereon a control program which causes a computer to perform functions of:
a color discrimination section which discriminates a color on the basis of color information of each portion in the color image, and extracts an area having a specific color;
a symbol composition section which specifies a symbol corresponding to the specific color by reference to a preliminarily stored first table correlating the specific color with the symbol indicating the specific color, and composes the specified symbol into the area having the specific color in the color image to generate a composite color image.

18. The computer-readable storage medium of claim 17, wherein
the symbol composition section further specifies a configuration of the symbol corresponding to a color information level of the specific color by reference to a preliminarily stored second table correlating the color information level of the specific color with the configuration of the symbol, and composes the specified symbol with the specified configuration into the area having the specific color to generate the composite color image.

19. The computer-readable storage medium of claim 18, wherein
the color information comprises R G B values; and
the color information level is a level of R value in cases where the specific color is red, a level of G value in cases where the specific color is green, and a level of R and G values in cases where the specific color is yellow.

20. The computer-readable storage medium of claim 17, wherein the symbol composition section arranges the symbol within the area having the specific color to generate the composite color image.

21. The computer-readable storage medium of claim 17, wherein the symbol comprises a capital letter of a name of the specific color.

22. The computer-readable storage medium of claim 17, wherein the specific color comprises a color which is difficult to be discriminated by a color vision defective.

23. The computer-readable storage medium of claim 17, wherein the specific color comprises a first color which is difficult to be discriminated by a color vision defective and a second color, where the color vision defective recognizes the first color as the second color.
